(19) United States
(12) Patent Application Publication
(10) Pub. No.: US 2008/0245539 A1
(43) Pub. Date: Oct. 9, 2008

(54) Soil Tilling Device

(75) Inventor: Gianluca Di Girolamo, Pianella (PE) (IT)

Correspondence Address: NIXON & VANDERHYE, PC, 901 NORTH GLEBE ROAD, 11TH FLOOR, ARLINGTON, VA, 22203, US

(73) Assignee: MO.ME. MODELLI MECCANICI S.r.l., Loreto Aprutino (PE) (IT)

(21) Appl. No.: 12/066,120

(22) PCT Filed: Sep. 18, 2006
(86) PCT No.: PCT/IB2006/053340

§ 371 Date: Mar. 19, 2008

(30) Foreign Application Priority Data
Sep. 16, 2005 (IT) PE2005A000010

(51) Int. Cl. A01B 33/02

(52) U.S. Cl. 172/508

(57) ABSTRACT

A soil tilling device, in particular a rotary tiller, a motor hoe or a motocultivator of the kind comprising one or more soil blades (2), assembled on a rotating driven shaft (1), apt to work the soil, avoiding the accumulation of either twigs, weeds, pruning remains or any kind of branches at the soil blades and at the shaft, since twigs and others undergo a reduction in size and length preventing the twining thereof due to one or more subsidiary blades (4, 9) placed at the sides of said soil blades (2), at said shaft (1).

The present invention is related to a soil tilling device, in particular a rotary tiller, a motor hoe or a motocultivator of the kind comprising one or more soil blades assembled on a rotating driven shaft, apt to work the soil.

Devices of the above specified type are known, being employed in agriculture for breaking up superficial clods of soil intended either for sowing or for planting or anyway for subsequent treatments. Oftentimes, such devices are used on soils where weeds, twigs, plants, bushes are rooted or where, for instance, pruning remains are present, which tends to remain entangled at the soil blades and to twine around the shaft.

Hence, the soil working must be preceded by an accurate soil cleaning, otherwise the utilization of these devices would require stops for freeing the device itself from these remains, an operation possibly complicated and uncomfortable.

The technical problem at the root of the resent invention is to provide a soil tilling device allowing to obviate to the drawback mentioned with reference to the prior art.

Such a problem is solved by a device as above specified, comprising at said shaft one or more subsidiary blades placed at the sides of said soil blades.

The main advantage of the soil tilling device according to the present invention consists in avoiding the accumulation of either twigs, weeds, pruning remains or any kind of branches at the soil blades and at the shaft, since twigs and others undergo a reduction in size and length preventing the twining thereof.

The present invention will be hereinafter described with reference to one preferred embodiment thereof, given for an illustrative and non-limiting purpose with reference to the annexed drawings wherein:

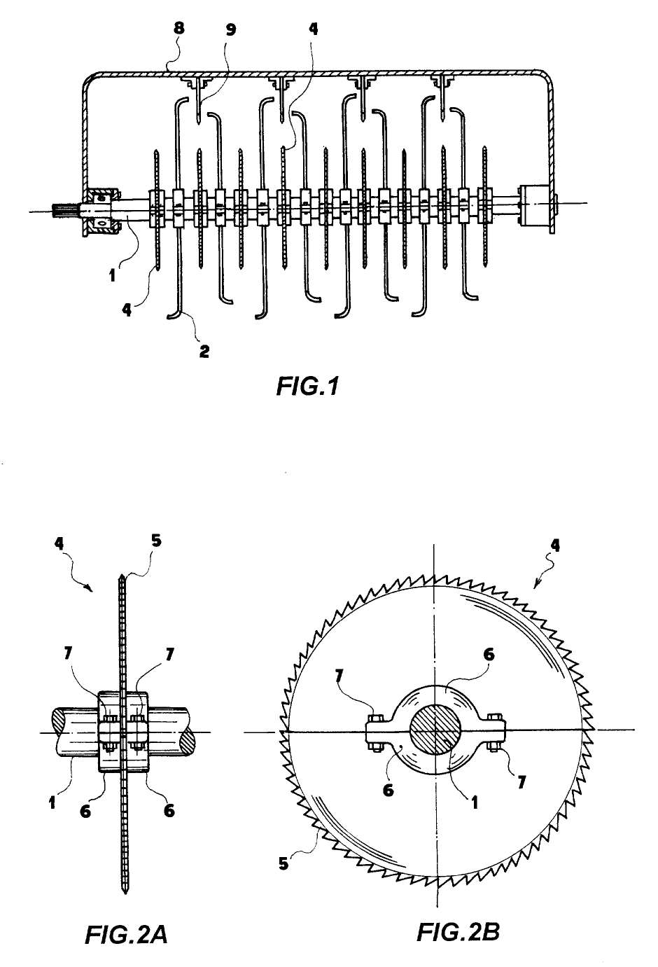

FIG. 1 shows a schematic and partially sectioned view of a detail of a soil tilling device according to the invention, exemplifying the most relevant peculiarities;

FIGS. 2A and 2B show two views of a first feature of the device in FIG. 1 respectively; and

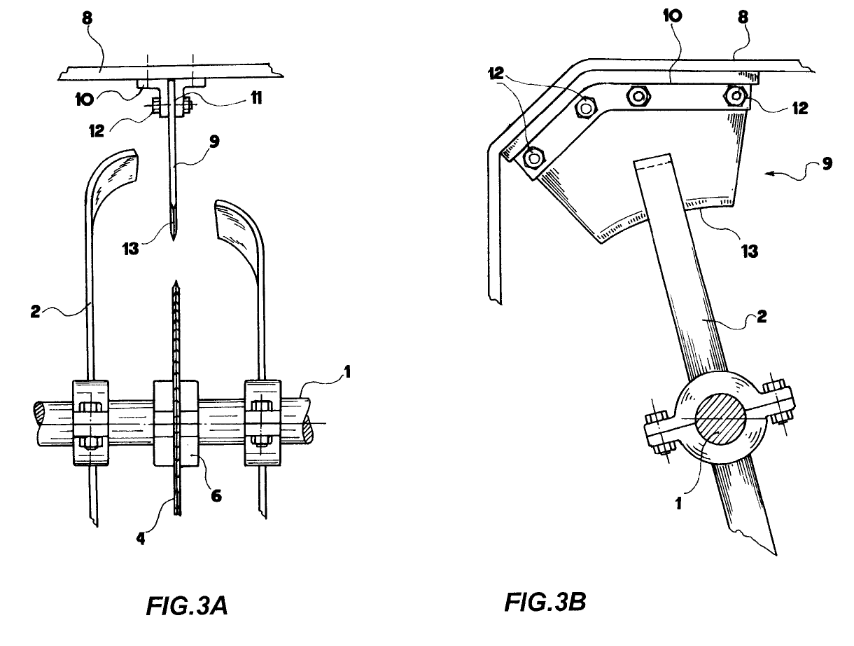

FIGS. 3A and 3B show two views of a second feature of the device in FIG. 1 respectively.

With reference to the drawings, a soil tilling device, in particular a motocultivator, is partially shown. This motocultivator, according the typology thereof, is usually linked to a self-moving equipment, particularly a tractor, trailing the chassis thereof and providing the device with the torque for rotating the blades.

However, it is intended that what it is hereinafter described can also be applied to rotary tillers and motor hoes having the engine directly mounted on the chassis.

Said device comprises a shaft 1, mounted on a mobile chassis of the device, driven in rotation by driving means not shown, on which soil working blades, referenced as soil blades 2 in the following.

The present embodiment of the device comprises a plurality of first subsidiary blades 4, assembled on the shaft 1, one between each of the soil blades 2.

In particular, first subsidiary blades 4 are placed at the sides of said soil blades 2, at said shaft and they are positioned so as to not directly interfere with the soil or to superficially interfere with it. They are driven in rotation by the shaft 1 and have a shorter or equal projection from the shaft 1 with respect to those of the soil blades 2.

In the present embodiment, said subsidiary blades 4 are disc-shaped and have, at the peripheric edge thereof, a saw profile 5.

Each first subsidiary blade 4 is formed by a pair of half-blades, i.e. by two adjacent discs, each provided with a holed half-joint 6. The half-discs and the half-joints 6 are integral to each other due to first screw means 7, i.e. nuts and bolts.

The action of first subsidiary blades is particularly to cut and to chop weeds, shrubs or pruning remains placed on the soil, preventing them to be dragged by the soil blades 2 and to be tangled around the shaft 1. The remains are particularly cut if they are trapped between the subsidiary blade 4 and the soil under working.

However, it is intended that this is only one of the possible embodiments of mobile first subsidiary blades 4. For instance, they may be also knife-shaped or octagon-shaped with sharpened edges.

The shaft 1, the soil blades 2 and the first subsidiary blades 4 are protected by a guard or by a casing 8, integral with the mobile chassis of the device, with a safety purpose.

The present embodiment of the device comprises a plurality of second subsidiary blades 9, fixed and assembled projecting themselves form an inner surface of the guard 8, one between each of the soil blades 2 and according to a position substantially coplanar to said first subsidiary blades 4.

Second subsidiary blades 9 project from the guard acting as stationary member with respect to the shaft 1 and the other blades 2 and 4, so as to be placed between said soil blade 2.

For the assembling, the guard 8 has, for each second subsidiary blade 9, a blocking member 10 which may be removable or fixed, e.g. connected to the guard by welding.

The blocking member 10 has an assembling slit 11 and a hole corresponding to an analogous hole in the subsidiary blade 9 which is inserted into the slit 11 and removably secured by second screw means 12.

Each second subsidiary blade 9 has a respective sharpened edge 13 curved, substantially circular with a curvature radius lower than the distance between the edge and the shaft 1, with the respective concavity positioned toward the shaft 1 itself. Second subsidiary blades substantially project orthogonally to the shaft 1 and to the guard assembling surface.

The action of the second subsidiary blades 9 is of receiving onto the concavity thereof branches or pruning remains driven in rotation by the soil blades 2, cutting them and preventing them to be twined by the shaft 1 at the guard 8, hampering the soil working.

Second subsidiary blades 9 might have also alternative shapes, e.g. knife-shape.

However, it is intended that a device according to the invention could be assembled alternatively with first subsidiary blades 4, second subsidiary blades 9 or both, according to the typology of the soil to be worked.

A man skilled in the art, for achieving further and incidental requirements, may introduce several further changes and variations to the above described soil tilling device, all of them in any case falling within the protection scope of the present invention, as defined by the annexed claims.

1. Soil tilling device, in particular a rotary tiller, a motor hoe or a motocultivator of the kind comprising one or more soil blades, assembled on a rotating driven shaft apt to work the soil, characterized in that it comprises at said shaft one or more subsidiary blades placed at the sides of said soil blades.

2. Device according to claim 1, wherein said one or more subsidiary blades are connected to the shaft, being driven in rotation by the latter, said subsidiary blades having a shorter projection from the shaft with respect to the soil blades.

3. Device according to claim 2, wherein said one or more subsidiary blades are disc-shaped and have, at the peripheric edge thereof, a saw profile.

4. Device according to claim 1, wherein said one or more subsidiary blades are fixed with respect to the soil blade and project from a stationary member, so as to be placed between said soil blades.

5. Device according to claim 4, wherein said stationary member is a protection guard.

6. Device according to claim 4, wherein said one or more subsidiary blades have a curved cutting edge, with a concavity positioned toward the shaft.

7. Device according to claim 1, wherein said one or more subsidiary blades substantially project orthogonally to the shaft.

8. Device according to claim 1, comprising: one or more first subsidiary blades connected to the shaft, being driven in rotation by the latter, said subsidiary blades having a shorter projection from the shaft with respect to the soil blades; and one or more second subsidiary blades fixed with respect to the soil blade and projecting from a stationary member, so as to be placed between said soil blades.
